(19) United States
(12) Patent Application Publication
(10) Pub. No.: US 2007/0060460 A1
(43) Pub. Date: Mar. 15, 2007

(54) Folding unit upper part

(75) Inventor: Klaus Theilacker, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/516,152

(22) Filed: Sep. 5, 2006

(30) Foreign Application Priority Data
Sep. 7, 2005 (DE) 10 2005 042 345.0

(51) Int. Cl. B31F 1/10

(52) U.S. Cl. 493/434

(57) ABSTRACT

A folding unit upper part assigned to a folder is disclosed. The utility can be widened for the folding unit upper part, having at least two folding formers with associated inlet rolls and pulling groups, by it being possible for at least one element of the folding unit upper part to be varied in accordance with a peripheral parameter.

This application claims the priority of German Patent Document No. 10 2005 042 345.0, filed Sep. 7, 2005, the disclosure of which is expressly incorporated by reference herein.

### BACKGROUND AND SUMMARY OF THE INVENTION

The invention relates to a folding unit upper part assigned to a folder, having at least two folding formers with associated inlet rolls and pulling groups.

The folding unit upper parts of the known folding devices are permanently matched to given peripheral parameters, such as web width, cylinder diameter and the like. These arrangements cannot therefore be used universally. Instead, for each customer job, a specific folding unit upper part has to be designed and produced as a function of the respectively given parameters. This proves to be illogical and has an unfavorable effect on the economy.

On this basis, it is an object of the present invention to provide a folding unit upper part module which can be used for cases with different parameters.

According to a first principle of the invention, this object is achieved by at least some of the folding formers, together with associated inlet rolls and pulling groups, being adjustable laterally and symmetrically with respect to the center of the machine.

This ensures that the folding unit upper part can be adapted to different cylinder lengths. In the case of smaller web widths, the folding formers move together more and vice versa. Since the folding formers, together with the associated peripheral elements, can be adjusted laterally, these subassemblies merely need to be displaced laterally as a function of the given web width in order to adapt the folding unit upper part to the given web width.

In simple cases with a given, fixed web width, it is sufficient to set the folding formers, together with the associated peripheral elements, which means inlet rolls and pulling groups, during the commissioning of the machine and to fix them in this position. The measures according to the invention, however, also offer the possibility of processing different web widths. In this case, the folding formers, together with the associated peripheral elements, are positioned as a function of the respective production. This can be done manually or preferably by motor.

Expediently, the folding formers, together with the associated peripheral elements, can in each case be accommodated on a carriage which can be adjusted laterally with respect to the center of the machine. In this way, the result in each case is a complete, displaceable subassembly containing units, which makes the setting easier.

The setting can be carried out by a motor in order to achieve a high operating convenience. In this case, the laterally adjustable carriages can expediently engage with threaded sections running in opposite directions of a pulling spindle that can be driven by means of a motor. This results in a comprehensible and very rugged arrangement which, in the case of a change in the web width, permits fast and convenient setting of the folding unit upper part.

In order to adapt the folding unit upper part to different cylinder diameters of the upstream press, according to a further principle of the invention, at least each second and following folding former can be assigned at least one adjustably arranged deflection roll. In cases in which only adaptation to different cylinder diameters is concerned, this measure is given independent significance. However, the aforementioned measures are expediently provided in combination with measures for adapting to the web width.

According to an advantageous refinement of the above measures, the deflection roll can be accommodated on an adjustably arranged carrier, which is constructed as a sliding carriage which is accommodated on guides on the frame and can be fixed in any desired position. The ability of the carriage to be displaced permits simple, continuous adjustability.

In order to adapt the folding unit upper part to folders having a different number of folding units, the folding unit upper part according to a further, independent principle of the invention has space on the folder side for a plurality of outlets with respectively associated pulling group and deflection rolls assigned to the latter, holding means being provided on the frame for each outlet, to which the respectively associated pulling group, together with associated deflection rolls, can be fitted as desired. Where it is a matter of adapting the folding unit upper part only to the different number of transverse folding units of folders, the above measure is given independent significance. However, this is expediently provided in combination with one or more of the above measures.

### BRIEF DESCRIPTION OF THE DRAWINGS

An exemplary embodiment of the invention will be explained in more detail below by using the drawings, in which:

FIG. 1 shows a view of a folding device comprising a folder and associated folding unit upper part;

FIG. 2 shows an example of laterally adjustable former subassemblies in a position adapted to a great web width; and

FIG. 3 shows the arrangement according to FIG. 2 in a position adapted to a small web width.

### DETAILED DESCRIPTION OF THE DRAWINGS

The basic construction and the mode of action of folding devices are known per se and therefore do not require any more detailed explanation in the present connection.

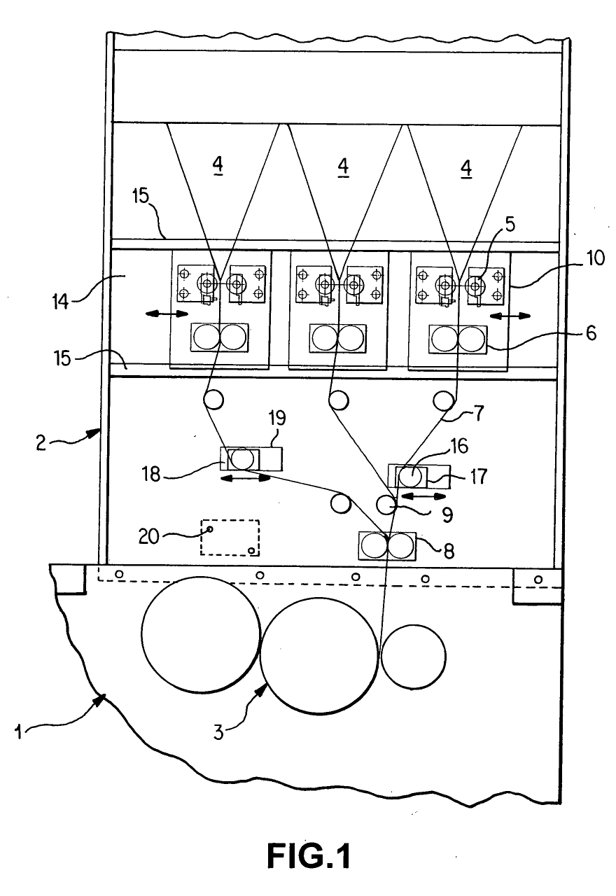

The arrangement on which FIG. 1 is based contains a folder 1 and a folding unit upper part 2 arranged above the folder. The folder 1 has a box-like machine frame having two side walls, on which the cylinders of a cross-cutting and folding unit 3 are arranged here. The folding unit upper part 2 in the example illustrated has only one side wall placed on a side wall of the folder 1. The elements projecting from the sidewall are accordingly arranged in a cantilever fashion.

The folding unit upper part 2 contains a plurality of folding formers 4, 3 in the example illustrated, arranged beside one another for the production of a continuous longitudinal fold of the printing material webs led over them. The former noses are flanked by associated inlet rolls 5. Located under the latter in each case is a pulling group 6 assigned to the folding former 4 located above it and arranged centrally in relation to the latter, which is able to exert a pulling force on the printing material web running over the associated folding former. The pulling groups 6 in each case comprise driven pull rolls, which are provided with pulling and supporting rings assigned to one another.

Each folding unit 3 of the folder 1 is supplied with one or more longitudinally folded printing material webs 7 laid on one another. For this purpose, the folding unit upper part 2 is provided with a number of outlets corresponding to the number of folding units 3 of the folder 1, to which outlets in each case a further pulling group 8 having deflection rolls 9 arranged upstream is assigned. In the example illustrated, the folder 1 contains only one folding unit 3. Accordingly, only one outlet with an associated pulling group 8 and upstream deflection rolls 9 is provided in the folding unit upper part, via which outlet all the longitudinally folded printing material webs 7 leave the folding unit upper part 2 as an overall package.

The folding unit upper part 2 is constructed here as a module which can be used universally, that is to say adapted to different peripheral parameters, such as press or folder parameters. One important parameter is the web width, that is to say the width of the printing material webs 7 processed. The web width is limited by the cylinder length of the press. The cylinder length gives the maximum web width that can be processed.

The position of the folding formers 4 depends on the web width processed. The greater the web width, the further the folding formers 4 have to be removed from one another and vice versa. In this case, an arrangement symmetrical with respect to the center of the machine is expediently always maintained. Given an odd number of folding formers, as in the present example, the respective central folding former 4 remains stationary and only the outer folding formers flanking this have to change their position.

Given an even number of folding formers, for example two folding formers, these are positioned symmetrically in relation to the center of the machine.

In order to be able to adapt the module forming the folding unit upper part 2 simply to different web widths, the folding formers 4, together with the respectively associated inlet rolls 5 and pulling group 6, i.e., together with the respectively associated peripheral elements, are arranged to be laterally adjustable. Each folding former 4, together with the associated inlet rolls 5 and the associated pulling group 6, is expediently accommodated on a common carriage 10, which is arranged such that it can be adjusted laterally on the frame of the folding unit upper part 2. In simple cases, it is sufficient if the carriages 10 can be displaced manually and fixed in the desired position. This is primarily suitable when the web width remains constant. In such cases, the carriages 10 are brought into the necessary position during the commissioning of the arrangement and fixed in this position.

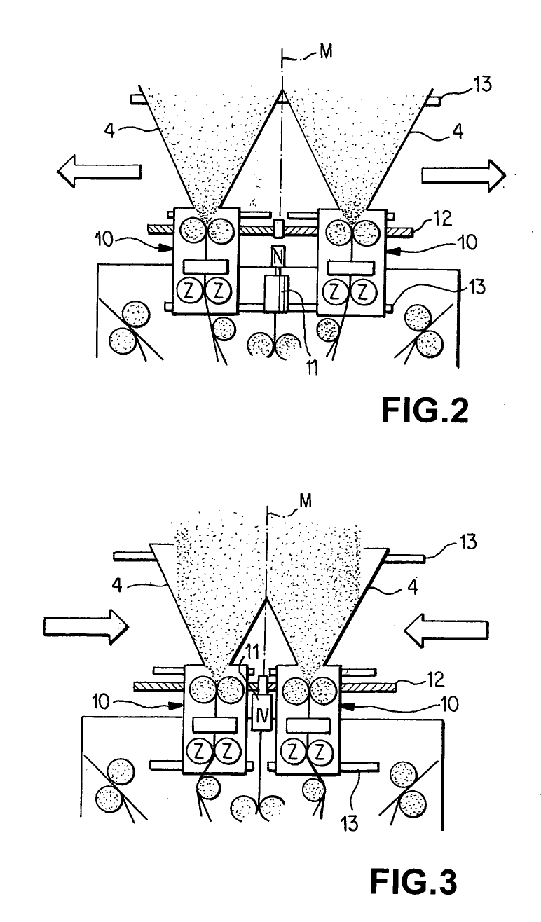

However, it is often desired to be able to process changing web widths, for example a wide newspaper format overnight and a narrower insert format during the day. In order here to make appropriate adaptation of the position of the folding formers 4 and of the associated peripheral elements easier, motor adjustability of the carriages 10 can be provided. To this end, as can be gathered from FIGS. 2 and 3, a threaded spindle 12 that can be driven by means of an associated motor 11 can advantageously be provided, the threaded spindle 12 having threaded sections running in opposite directions, which each engage with a carriage 10 that can be adjusted symmetrically with respect to the center of the machine. In this case, by actuating the motor 11, it is possible to displace the folding formers 4 from the position on which FIG. 2 is based, corresponding to a great web width, into the position on which FIG. 3 is based, assigned to a smaller web width, and vice versa.

FIGS. 2 and 3 are based on an arrangement having two folding formers 4, that is to say having an even number of folding formers 4. In such an arrangement, the folding formers are located on the left and right of the center of the machine M, indicated by dash-dotted line in FIGS. 2 and 3, and are adjusted symmetrically in relation thereto. In an arrangement having an odd number of folding formers 4, for example three folding formers 4 as in FIG. 1, the respective central folding former 4 remains stationary and only the outer folding formers are adjusted laterally with respect to the central one. The central folding former 4, together with the associated peripheral elements, can in this case be arranged to be stationary. Of course, however, the central folding former 4, together with the associated peripheral elements, can also be accommodated on a laterally adjustable carriage which, however, is generally not adjusted or adjusted only in order to change or set the desired center of the machine.

The laterally adjustable subassemblies are accommodated on associated longitudinal guides, as indicated in FIGS. 2 and 3 by guide bars 13. In order to achieve greater stability, in addition to the longitudinal guides assigned to the carriages 10, a longitudinal guide supporting the upper edge region of the folding formers 4 can also be provided. The elements forming the longitudinal guides can be fixed to the side wall of the folding unit upper part 2. In the example on which FIG. 1 is based, the side wall of the folding unit upper part 2 is provided with a window 14 which is continuous over virtually the entire width of the folding unit upper part 2 and into which the carriage 10 is inserted. The upper and lower flanks of the window 14 are in this case formed as longitudinal guides 15 in which the carriages 10 engage with suitable guide means. These can be formed, for example, as prism-shaped rails. The longitudinal guides 15 can accordingly be formed as roof-shaped guide rails. The window 14 provided in order to accommodate the carriages 10 results in a very flat arrangement, as can be seen.

A further, important parameter for the configuration of a folding unit upper part is the cylinder diameter of the respective press upstream, which can be different from case to case. In every case, the web path must be such that the crosscut made in the folder 1 coincides with the start of the print, which is designated the cut register. For one web, the cut register can be set by means of suitable rotation of the cylinders of the press. For the further webs, the cut register must be achieved by means of suitable diversions, over which the relevant webs are led in the folding unit upper part 2.

In order to make a simple adaptation to different cylinder diameters possible, at least each second and following web is in each case assigned at least one adjustably arranged deflection roll 16. In the example on which FIG. 1 is based, in each case an adjustably arranged deflection roll 16 is assigned to the printing material webs 7 running over the two outer folding formers 4. The cut register of the printing material web running over the central folding former 4 is set here by means of rotating the cylinders of the press upstream. Of course, however, this web could also be assigned an adjustable deflection roll.

The adjustable deflection rolls 16 are each accommodated on an associated carrier 17, which is expediently constructed as a sliding carriage which is accommodated such that it can be displaced on an associated longitudinal guide of the side wall of the folding unit upper part 2. This side wall can expediently have the slot 18 which is assigned to the sliding carriage forming the carrier 17 and whose longitudinal edges can be formed as the longitudinal guides assigned to the respectively associated carrier 17.

Motor adjustment of the carrier 17 together with the deflection roll 16 accommodated in each case is conceivable. As a rule, however, the ability to be displaced manually is sufficient here. This is because the adjustable deflection rolls 16 are merely set during the commissioning and then fixed. In order to permit subsequent fine setting, the deflection rolls 16 can likewise be arranged to be adjustable with respect to the respectively associated carrier 17.

The carriers 17 that can be displaced along the associated longitudinal guides 19 can be fixed by using suitable clamping elements, such as screws, etc. The same applies to the fixing of the displaceable carriages 10. Instead of carriages 10 or carriers 17 that can be displaced along their longitudinal guides, it is of course also possible for subassemblies which can be transposed along an associated series of holes, etc., to be provided. By comparison, however, the design with displaceable carriages permits the ability to be adjusted continuously.

A further, peripheral parameter to which the folding unit upper part 2 has to be adapted is the number already mentioned at the beginning of the folding units 3 of the folder 1. There are folders having one folding unit 3, as shown in FIG. 1, and folders having two and more folding units. The folding unit upper part 2 needs a number of outlets corresponding to the number of folding units 3 present in the folder 1. As already mentioned above, a pulling group 8 is needed in the region of each outlet.

In order to be able to adapt the folding unit upper part 2 to any folder, in the lower edge region of the folding unit upper part 2 there is space for a maximum possible number of outlets with suitable fixing means, indicated by holes 20 here, for the optional fitting of the necessary pulling group 8 and deflection rolls 9 possibly assigned to the latter. In the example on which FIG. 1 is based, the folder 1 contains only one folding unit 3. Accordingly, only one pulling group 8 is installed, which results in the necessary one outlet. If use is made of a folder having two crossfolding units, a second pulling group can be installed at the point marked by broken lines. The fixing possibilities needed for this purpose, here in the form of the holes 20, are provided from the start, which makes adaptation easier to the number of crossfolding units found.

The above-described example results in a folding unit upper part module which can be used universally, which can be employed irrespective of the web width, the cylinder diameter and the number of crossfolding units and can be adapted to the relationships found in each case, which permits efficient production and stock keeping.

### LIST OF REFERENCE SYMBOLS

1 Folder structure
2 Folding unit upper part
3 Folding unit
4 Folding former
5 Inlet rolls
6 Pulling groups
7 Printing material webs
8 Pulling group
9 Deflection rolls
10 Carriage
11 Motor
12 Threaded spindle
13 Guide bars
14 Window
15 Longitudinal guides
16 Deflection rolls
17 Carrier
18 Slots
19 Longitudinal guides
20 Holes

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folding unit upper part assigned to a folder, having at least two folding formers with associated inlet rolls and a pulling group, wherein at least one of the folding formers, together with the associated inlet rolls and pulling group, is adjustable laterally and symmetrically with respect to a center of the folding unit upper part.

2. The folding unit upper part according to claim 1, wherein two folding formers, together with the associated inlet rolls and pulling group, are adjustable and are each disposed on a laterally adjustable carriage.

3. The folding unit upper part according to claim 2, wherein the laterally adjustable carriages respectively engage with threaded sections running in opposite directions of a threaded spindle that is driveable by means of a motor.

4. The folding unit upper part according to claim 2, wherein the carriages are fixable in a desired position.

5. The folding unit upper part according to claim 2, wherein, in a region of at least one side wall there is provided at least one window which is assigned to the carriages and which is provided with longitudinal guides assigned to the carriages.

6. The folding unit upper part according to claim 1, wherein when the folding unit upper part has an odd number of folding formers, at least folding formers flanking a central folding former are adjustable laterally with respect to the central folding former.

7. The folding unit upper part according to claim 1, wherein at least one adjustably arranged deflection roll is assigned to a printing material web running over a second one of the two folding formers.

8. The folding unit upper part according to claim 7, wherein the deflection roll is disposed on an adjustably arranged carrier that is fixable in a desired position.

9. The folding unit upper part according to claim 8, wherein a position of the deflection roll is adjustable on the carrier.

10. The folding unit upper part according to claim 8, wherein the carrier is a sliding carriage which is disposed on associated guides on a frame of the folding unit upper part.

11. The folding unit upper part according to claim 1, wherein in a region of an edge on a folder side, a space is provided for a plurality of outlets with an associated pulling group and deflection rolls, and wherein holding means are provided on a frame of the folding unit upper part for each outlet.

12. A folding unit upper part of a folder, comprising:
a folding former including associated inlet rolls and a pulling group; and
a laterally adjustable carriage, wherein the folder former is disposed on the laterally adjustable carriage.

13. The folding unit upper part according to claim 12, wherein the laterally adjustable carriage is moveable on a frame of the folding unit upper part.

14. The folding unit upper part according to claim 12, wherein the laterally adjustable carriage is moveable by a motor driven threaded spindle.

15. The folding unit upper part according to claim 12, further comprising a laterally adjustable deflection roll wherein a printing material web runs over the folding former and the deflection roll.

16. A method of configuring a folding unit upper part of a folder, comprising the step of:
laterally moving a carriage of the folding unit upper part, wherein a folding former including associated inlet rolls and a pulling group is disposed on the carriage.

17. The method according to claim 16, wherein the step of laterally moving the carriage includes the step driving a threaded spindle by a motor, wherein the carriage is coupled to the spindle.

18. The method according to claim 16, further comprising the steps of:
changing a width of a printing material web processed by the folding unit upper part; and
laterally moving the carriage of the folding unit upper part to a position associated with the width of the printing material web.

19. The method according to claim 16, further comprising the step of laterally moving a deflection roll wherein a printing material web runs over the folding former and the deflection roll.

20. The method according to claim 19, wherein the step of laterally moving the deflection roll includes the step of laterally moving a carrier, wherein the deflection roll is disposed on the carrier.
